(19) United States
(12) Patent Application Publication
(10) Pub. No.: US 2019/0102824 A1
(43) Pub. Date: Apr. 4, 2019

(54) METHOD AND SYSTEM FOR INTELLIGENT SHOPPING, AND INTELLIGENT SHOPPING CART

(71) Applicant: BOE TECHNOLOGY GROUP CO., LTD., Beijing (CN)

(72) Inventors: Junmin Sun, Beijing (CN); Lei Cao, Beijing (CN); Yan Ren, Beijing (CN); Zifeng Wang, Beijing (CN); Lu Tong, Beijing (CN)

(21) Appl. No.: 16/102,354

(22) Filed: Aug. 13, 2018

(30) Foreign Application Priority Data
Sep. 30, 2017 (CN) 201710916842.5

(51) Int. Cl. G06Q 30/06; G01C 21/34

(52) U.S. Cl. CPC G06Q 30/0639; G01C 21/343; G06Q 30/0641; G06Q 30/0625; G06Q 30/0633

(57) ABSTRACT

The present disclosure provides a method and a system for intelligent shopping, and an intelligent shopping cart, and relates to the technical field for intelligent control. The method for intelligent shopping includes obtaining a list of commodities to be purchased, generating a target navigation route according to a current location and a preset area where each commodity to be purchased in the list of commodities to be purchased is located, and according to the target navigation route, guiding, in sequence, a user to go to the preset area where each commodity to be purchased in the list of commodities to be purchased is located, for shopping.

### CROSS REFERENCE

The present application claims the priority of Chinese Patent application No. 201710916842.5, filed on Sep. 30, 2017, and the entire contents thereof are incorporated herein by reference as part of the present application.

### TECHNICAL FIELD

The present disclosure relates to the technical field for intelligent control, and in particular, to a method and a system for intelligent shopping, and an intelligent shopping cart.

### BACKGROUND

With the rapid development of science and technology, intelligent control technology such as artificial intelligence is permeating into every area of human life. In these areas, smart retail is an important branch of Internet of Things (TOT) and artificial intelligence, and a complete intelligent shopping system will constitute an integral part for the future shopping model.

It should be noted that the information disclosed in the foregoing background section is only for enhancement of understanding of the background of the present disclosure and therefore may include information that does not constitute prior art that is already known to those of ordinary skill in the art.

### SUMMARY

According to some arrangements of the present disclosure, a method for intelligent shopping includes a list of commodities to be purchased is obtained, a target navigation route is generated according to a current location and a preset area where each commodity to be purchased in the list of commodities to be purchased is located, and according to the target navigation route, a user is guided in sequence to go to the preset area where each commodity to be purchased in the list of commodities to be purchased is located, for shopping.

In an exemplary arrangement of the present disclosure, the obtaining a list of commodities to be purchased includes creating communication with a client on which the list of commodities to be purchased is stored to obtain the list of commodities to be purchased, and/or receiving a shopping instruction for pre-selecting the commodities to be purchased, and generating the list of commodities to be purchased according to the shopping instruction.

In an exemplary arrangement of the present disclosure, the generating a target navigation route according to a preset area where each commodity to be purchased in the list of commodities to be purchased is located, includes generating a plurality of navigation routes according to the preset area where each commodity to be purchased in the list of commodities to be purchased is located, displaying the plurality of the navigation routes on a display window, and receiving one selected navigation route, which is selected in response to the plurality of the navigation routes, to be the target navigation route, and/or searching, in a shopping system, for at least one piece of commodity information matched with one or more commodities to be purchased in the list of commodities to be purchased according to the one or more commodities to be purchased, displaying the at least one piece of commodity information on a display window, receiving the one or more commodities to be purchased which are selected in response to the at least one piece of commodity information, and generating the target navigation route according to preset areas where the one or more commodities to be purchased are located.

In an exemplary arrangement of the present disclosure, after guiding a user to go to a preset area where any one of the commodities to be purchased is located according to the target navigation route, the method further includes communication with an electronic tag of the any one of the commodities to be purchased is created to obtain a precise location of the any one of the commodities to be purchased, a precise navigation route is generated according to the current location and the precise location of the any one of the commodities to be purchased, and the user is guided to go to the precise location where the any one of the commodities to be purchased is located according to the precise navigation route.

In an exemplary arrangement of the present disclosure, the method further includes commodity information of a commodity to be weighed is obtained while purchasing the commodity to be weighed, the commodity information of the commodity to be weighed includes a commodity price, a first weight of the selected commodities is read out, a second weight is read out after adding the commodity to be weighed, the weight of the commodity to be weighed is obtained according to the difference between the second weight and the first weight, a total price of the commodity to be weighed is generated according to the commodity information and the weight of the weighed commodity, and an identification code including the commodity information and the total price is generated.

According to some arrangements of the present disclosure, a system for intelligent shopping includes a list obtaining module configured to obtain a list of commodities to be purchased, a navigation generation module configured to generate a target navigation route according to a current location and a preset area where each commodity to be purchased in the list of commodities to be purchased is located, and a shopping guidance module configured to, according to the target navigation route, guide, in sequence, a user to go to the preset area where each commodity to be purchased in the list of commodities to be purchased is located, for shopping.

In an exemplary arrangement of the present disclosure, the system further includes a communication module configured to, after guiding a user to go to a preset area where any one of the commodities to be purchased is located according to the target navigation route, create communication with an electronic tag of the any one of the commodities to be purchased to obtain a precise location of the any one of the commodities to be purchased.

The navigation generation module is further configured to generate a precise navigation route according to the current location and the precise location of the any one of the commodities to be purchased; and the shopping guidance module is further configured to guide the user to go to the precise location where the any one of the commodities to be purchased is located.

In an exemplary arrangement of the present disclosure, the system further includes an information obtaining module configured to obtain commodity information of a commodity to be weighed while purchasing the commodity to be weighed, the commodity information of the commodity to be weighed including a commodity price, a weighing module configured to read out a first weight of the selected commodities, read out a second weight after adding the commodity to be weighed, and obtain the weight of the commodity to be weighed according to the difference between the second weight and the first weight, an identification code generation module configured to generate a total price of the commodity to be weighed according to the commodity information and the weight of the weighed commodity, and generate an identification code including the commodity information and the total price.

According to some arrangements of the present disclosure, a system for intelligent shopping includes a processor, and a memory in which instruction executable for the processor is stored. The processor is configured to perform any one of the above-mentioned methods.

According to some arrangements of the present disclosure, an intelligent shopping cart includes a display identification area, a commodity placement area and a drive control area.

The display identification area includes a communication device and a display window, and the communication device and/or the display window is/are configured to obtain a list of commodities to be purchased.

The commodity placement area includes a bearing plate and a holding chamber on the bearing plate.

The drive control area includes wheels, a drive device and an LIDAR sensor. The LIDAR sensor is configured to obtain a current location and a location in preset area where each commodity to be purchased in the list of commodities to be purchased is located, and guide a user to go to the preset area where each commodity to be purchased is located.

In an exemplary arrangement of the present disclosure, the commodity placement area further includes a weighing sensor under the bearing plate.

According to some arrangements of the present disclosure, there is provided a non-transitory computer readable medium, in which instruction is stored. When the instruction is executed by the processor of any one of the above systems, the any one of the above systems performs any one of the above mentioned methods.

It is to be understood that both the foregoing general description and the following detailed description are exemplary and explanatory only and are not restrictive of the disclosure.

### BRIEF DESCRIPTION OF THE DRAWINGS

The accompanying drawings, which herein are incorporated in and constitute a part of the description, illustrate arrangements consistent with the present disclosure, and, together with the description, serve to explain the principles of the present disclosure. Obviously, the drawings descripted as follows are merely some arrangements of the present disclosure, and those skilled in the art can also obtain other drawings based on these drawings without any creative labor.

FIG. 1 is a schematic diagram illustrating a method for intelligent shopping according to an arrangement of the present disclosure;

FIG. 2 is a flowchart illustrating a method for intelligent shopping according to an arrangement of the present disclosure;

FIG. 3 is a schematic diagram illustrating a method for weighing a commodity according to an arrangement of the present disclosure;

FIG. 4 is a block diagram illustrating a system for intelligent shopping according to an arrangement of the present disclosure;

FIG. 5 is a front view schematically illustrating an intelligent shopping cart according to an arrangement of the present disclosure;

FIG. 6 is a side view schematically illustrating an intelligent shopping cart according to an arrangement of the present disclosure;

FIG. 7 is a schematic diagram illustrating a partition for the holding space of the intelligent shopping cart according to the arrangement of the present disclosure;

FIG. 8 is a schematic diagram illustrating an implementation of weighing function in an arrangement of the present disclosure;

FIG. 9 is a schematic diagram illustrating another implementation of weighing function in an arrangement of the present disclosure;

FIG. 10 is a schematic diagram illustrating a layout of a drive control area in an arrangement of the present disclosure;

FIG. 11 is a schematic diagram illustrating another layout of a drive control area in an arrangement of the present disclosure;

FIG. 12 is a schematic diagram illustrating another layout of a drive control area in an arrangement of the present disclosure;

FIG. 13 is a schematic diagram illustrating electronic devices in an arrangement of the present disclosure; and

FIG. 14 is a schematic diagram illustrating a program product according to an arrangement of the present disclosure.

### DETAILED DESCRIPTION

Example arrangements will now be described more fully with reference to the accompanying drawings. However, example arrangements can be implemented in various forms and should not be construed as being limited to the examples set forth herein; rather, these arrangements are provided so that the present disclosure will be more comprehensive and complete, and will fully convey the concept of the example arrangements for those skilled in the art. The features, structures, or characteristics described may be combined in any suitable manner in one or more arrangements.

Moreover, the drawings are merely schematic illustrations of the present disclosure and are not necessarily drawn to scale. The same reference numerals in the drawings denote the same or similar parts, and their repeated description will be omitted. Some of the block diagrams shown in the drawings are functional entities which do not necessarily have to correspond to physically or logically independent entities. These functional entities may be implemented in software, or may be implemented in one or more hardware modules or integrated circuits, or may be implemented in different network and/or processor devices and/or microcontroller devices.

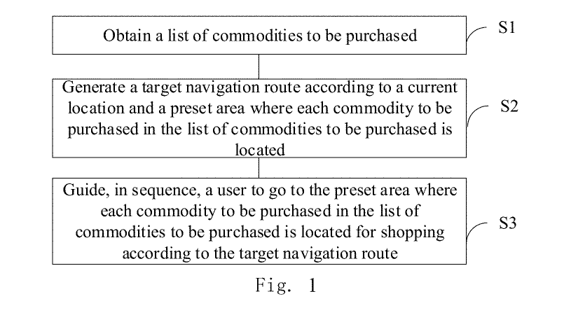

This example arrangement provides a method for intelligent shopping, as shown in FIG. 1, the method may include:

S1: a list of commodities to be purchased is obtained;

S2: a target navigation route is generated according to a preset area where each commodity to be purchased in the list of commodities to be purchased is located;

S3: according to the target navigation route, a user is guided in sequence to go to the preset area where each commodity to be purchased in the list of commodities to be purchased is located, for shopping.

The current location and the preset area where each commodity to be purchased in the list of commodities to be purchased is located can be located by the LIDAR sensor mounted on the intelligent shopping cart.

In the method for intelligent shopping provided in the exemplary arrangement of the present disclosure, a target navigation route is automatically generated according to the user's list of commodities to be purchased, so as to guide the user to go to the area where each commodity to be purchased is located for shopping. In this way, by providing the user with a shopping guide route, on the one hand, the user can be guided to the area where each commodity to be purchased is located and this avoids the situation in which the user cannot find the shopping area, thus providing the user with a good shopping experience; on the other hand, the most reasonable shopping route can be customized for users, thus saving shopping time and increasing shopping efficiency.

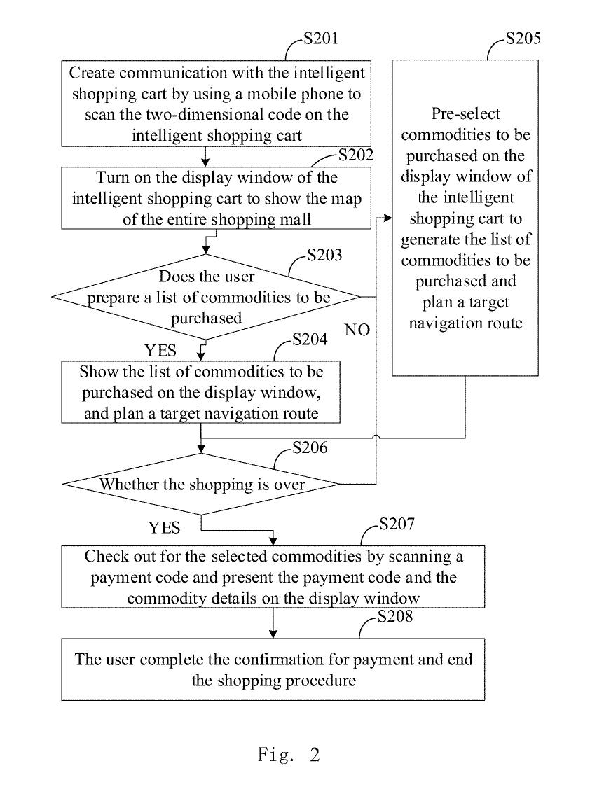

The method for intelligent shopping provided in this exemplary arrangement will be described in detail with reference to FIG. 2 below.

In S1, a list of commodities to be purchased is obtained.

In one arrangement of the present example, a list of commodities to be purchased is prepared by the user in advance and stored in a client such as a mobile phone. In this case, the method for obtaining the list of commodities to be purchased may include: the intelligent shopping cart creating communication with the client storing the list of commodities to be purchased, so as to directly obtain the list of commodities to be purchased from the client.

The list of commodities to be purchased which is stored in the client may be stored in the notepad of the client in, for example, a text format. At this time, the intelligent shopping cart can directly identify the specific information from the obtained list of commodities to be purchased.

Alternatively, the list of commodities to be purchased which is stored in the client may also be stored in the photo library of the client, for example, in the format of a picture. At this time, the intelligent shopping cart needs to use image recognition technology to analyze and identify the contents in the picture in order to obtain the specific information from the list of commodities to be purchased.

It should be noted that since the picture recognition has lower accuracy and higher technical difficulty than the text recognition, this arrangement is optionally implemented by storing the list of commodities to be purchased in a text format.

In another arrangement of the present example, the user may not prepare a list of commodities to be purchased in advance, but may select the commodities to be purchased in the display window of the intelligent shopping cart. In this case, the method for obtaining the list of commodities to be purchased may include: the intelligent shopping cart receiving a shopping instruction for pre-selecting the commodities to be purchased, and generating the list of commodities to be purchased according to the shopping instruction.

In this case, the display window may include a display screen for presenting information and an operation area for inputting information; or, the display window may also be a touch screen with a touch function. In consideration of maximization of the display area of the display window and convenience for operation, the latter can be selected in this arrangement.

It should be noted that the relationship between the shopping instruction and the pre-selected commodity to be purchased may be an one-to-one relationship or an one-to-many relationship, as long as it is ensured that all commodities to be purchased are included when the final list of commodities to be purchased is generated, and with regard to this aspect, other limitations will not be intended to be added to the present disclosure.

For example, referring to FIG. 2, the user may create communication between a mobile phone and an intelligent shopping cart by using the mobile phone to scan the two-dimensional code on the intelligent shopping cart at S201. At this time, the display window on the intelligent shopping cart, such as the display screen, is turned on to show the map of the entire shopping mall for the user at S202. Responsive to determining that the user had prepared a list of commodities to be purchased in the note book of the mobile phone in advance (S203: YES), the intelligent shopping cart can directly obtain the list of commodities to be purchased and display it on the display window at S204. Responsive to determining that the user does not prepare a list of commodities to be purchased in advance (S203: NO), the commodities to be purchased can be pre-selected on the display window of the intelligent shopping cart, and at this time, the intelligent shopping cart can instantly generate a list of commodities to be purchased according to the commodities to be purchased that are pre-selected by the user at S205.

In S2, a target navigation route is generated according to a current location and a preset area where each commodity to be purchased in the list of commodities to be purchased is located.

The preset area refers to a classified area where the commodity to be purchased is located, such as a fruit area where the apple is located, a snack area where the biscuit is located, and the like; the target navigation route refers to a navigation route that ultimately guides the user for shopping.

In an arrangement of the present example, since there may be more than one navigation route generated according to the list of commodities to be purchased that is provided by the user (for example, some of navigation routes pass by the area where maternal and child products are located and some of navigation routes pass by the area where skin care products are located), the user can choose one navigation route as the target navigation route from the multiple navigation routes according to his/her own preferences.

Based on the above, the generating a target navigation route according to a preset area where each commodity to be purchased in the list of commodities to be purchased is located, may include:

In S211, a plurality of navigation routes are generated according to the preset area where each commodity to be purchased in the list of commodities to be purchased is located and the plurality of the navigation routes are displayed on a display window.

In S212, one selected navigation route which is selected in response to the plurality of the navigation routes is received to be the target navigation route.

In another arrangement of the present example, since a plurality of commodities can be obtained according to matching of the commodities to be purchased in the list of commodities to be purchased provided by the user (for example, a moisturizing cleansing milk or anti-acne type cleansing milk can be obtained according to functional classification of the cleansing milk; Nivea, Pechoin, or the like can be obtained according to the brand of the cleansing milk; and the cleansing milks fallen within different price ranges can be obtained according to the price classification), the users can choose one or more of the multiple commodities as their target commodities according to their preferences, and a target navigation route is generated according to a preset area where each selected target commodity is located.

Based on the above, the generating a target navigation route according to a preset area where each commodity to be purchased in the list of commodities to be purchased is located, may include the following:

In 221, at least one piece of commodity information matched with one or more commodities to be purchased in the list of commodities to be purchased is searched for in a shopping system according to the one or more commodities to be purchased and the at least one piece of commodity information is displayed on a display window.

In the 222, the one or more commodities to be purchased which are selected in response to the at least one piece of commodity information are received and the target navigation route is generated according to preset areas where the one or more commodities to be purchased are located.

In this arrangement, when obtaining at least one piece of commodity information that matches one or more commodities to be purchased, the user may extract and read the name and price of the similar commodities according to the keyword, so as to confirm a commodity as the commodity to be purchased which is needed by the user on the display window. On this basis, after the intelligent shopping cart guides the user to the corresponding preset area according to the user-selected commodity to be purchased, the user can also confirm the desired commodity on site. If the selected commodity to be purchased is the desired commodity, the commodity is confirmed and added directly; if the selected commodity to be purchased is not the desired commodity, the user can also select other desired commodities for confirming and adding, and for the mistakenly selected commodity to be purchased, it can be canceled directly.

It should be noted that the above two implementations may be independently considered as factors for generating a target navigation route, or may be jointly considered as factors for generating a target navigation route, which is not limited thereto in this arrangement.

In S3, according to the target navigation route, a user is guided in sequence to go to the preset area where each commodity to be purchased in the list of commodities to be purchased is located, for shopping.

In this arrangement, the guiding in sequence a user to go to the preset area where each commodity to be purchased is located according to the target navigation route, may include the following:

S301: a current location and a location in a preset area where the next commodity to be purchased in the target navigation route is located are obtained;

S302: the user is guided to the preset area where the next commodity to be purchased is located according to the current location and the preset area where the next commodity to be purchased is located.

Since the preset area only refers to the approximate area where the commodity to be purchased is located, preset areas obtained by selecting specific commodities of any function, brand, or price range based on the commodities to be purchased which are provided by the user may not be different. Thus, the target navigation route can only guide the user to reach a rough area, but not a precise location of the selected specific commodity.

Based on the above, in order to obtain the location with better accuracy, after guiding a user to go to a preset area where any one of the commodities to be purchased is located according to the target navigation route, the method may further include the following:

S303: communication with an electronic tag of the commodities to be purchased is created to obtain a precise location of the commodities to be purchased;

S304: a precise navigation route is generated according to the current location and the precise location of the any one of the commodities to be purchased;

S305: the user is guided to go to the precise location where the any one of the commodities to be purchased is located according to the precise navigation route.

In this case, the electronic tag of the commodity to be purchased and the intelligent shopping cart can communicate through, but not limited to, a wireless connection such as infrared, Bluetooth, Zigbee, and WiFi (Wireless-Fidelity).

It should be noted that, during selection of the commodities to be purchased, or after addition of all the commodities to be purchased in the list of commodities to be purchased is completed, the user may also add a new list of commodities to be purchased at any time, and may go shopping according to the target navigation route that is updated in real time.

Furthermore, in the course of which the user is guided in sequence to go to the preset area where each commodity to be purchased is located according to the target navigation route and of which the user is guided to go to the precise location where the commodity to be purchased is located according to the precise navigation route, the intelligent shopping cart may also automatically avoid obstacles by using a plurality of ultrasonic sensors installed on the vehicle body, such as a handcart used by a cleaner, a restocking cart used by a stevedore, and other shoppers, so as to ensure that the intelligent shopping cart can safely reach the target area.

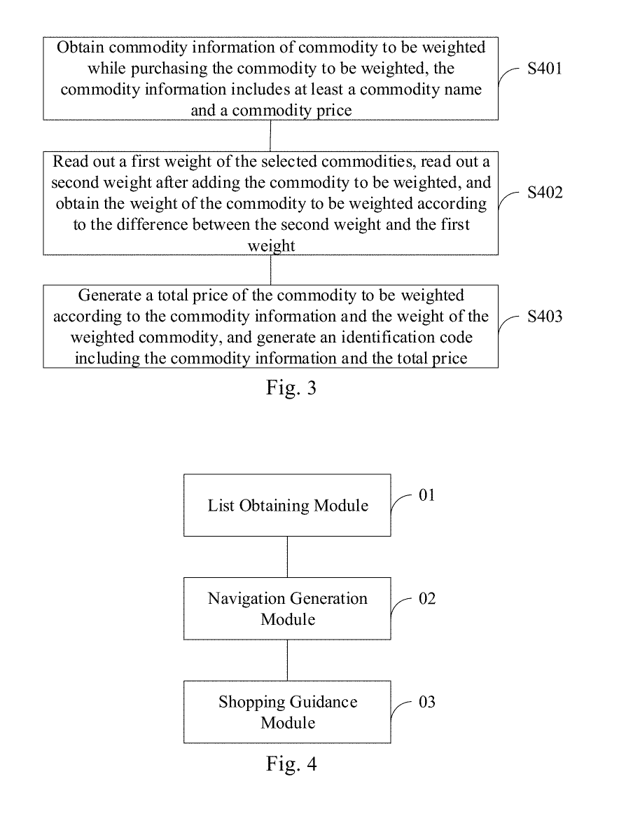

In the course of which the intelligent shopping cart guides the user to go shopping, if the user purchases some in-bulk commodities that need to be weighed, such as fruits or vegetables, the user may have to queue up for weighing sometimes, and this may decrease the shopping efficiency. Based on this, as shown in FIG. 3, the method for intelligent shopping that is provided by an arrangement of this example may include the following:

S401: commodity information of a commodity to be weighed is obtained while purchasing the commodity to be weighed, and the commodity information of the commodity to be weighed may include at least a commodity name and a commodity price;

S402: a first weight of the selected commodities is read out, a second weight after adding the commodity to be weighed is read out and the weight of this commodity to be weighed is obtained according to the difference between the second weight and the first weight;

S403: a total price of the commodity to be weighed is generated according to the commodity information and the weight of the weighed commodity and an identification code including the commodity information and the total price is generated.

In this case, the commodity to be weighed refers to an in-bulk commodity that needs to be weighed; the identification code refers to a bar code or a two-dimensional code for payment of the commodity, and the identification code at least carries the information of the commodity name and the commodity price. For the weighing commodity, the identification code is generated based on the unit price and actual weight of the selected in-bulk commodity, and carries commodity information such as the commodity name, the commodity price (i.e., the unit price), the commodity weight, the commodity total price and the like.

It should be noted that the selected commodity refers to a commodity that has been added to the intelligent shopping cart. At this time, the intelligent shopping cart has a first weight because it has been subjected to a certain load; however, if none of commodity has not been added to the intelligent shopping cart, that is, the intelligent shopping cart does not yet carries any commodity, the corresponding first weight is zero.

For example, when the user needs to purchase the commodity that needs to be weighed, the user can select the corresponding commodity information through the display window, and place the commodity to be purchased in the intelligent shopping cart after the confirmation. The commodity information includes at least the commodity name and the commodity price (i.e., the unit price). At this time, the weight of the selected commodity in the intelligent shopping cart is displayed as A kg, and the weight after adding the commodity to be weighed is displayed as B kg; in this case, the weight of the currently purchased commodity that needs to be weighed is (B-A) kg. On this basis, if the user wants to buy less, he/she must select this commodity on the display window before taking out the commodity and perform related operations. At this time, the intelligent shopping cart recounts the weight as C kg, and the weight of this commodity to be purchased is (C-A) kg. After the weighing is completed, the intelligent shopping cart can calculate the total price based on the price and weight of the selected commodity, and generate a bar code for payment.

In this way, the intelligent shopping cart can use its own weighing sensor to realize the weighing function of in-bulk commodity, and this solves the problem that users need to queue up for weighing, thus improving the shopping efficiency.

Furthermore, the intelligent shopping cart can also add an autonomous checkout function to save the waiting time for the checkout time. Based on this, as shown in FIG. 2, the method for intelligent shopping may further include the following:

S501: obtain identification codes which correspond to all of the selected commodities and check out according to the identification codes;

502: generate a payment code in response to the result for checkout, and present the payment code and the commodity details on the display window;

S503: receive payment confirmation information generated in response to the payment code so as to complete the shopping.

For example, after the intelligent shopping cart guides the user to the preset area where the commodity to be purchased is located, the user takes out the desired commodity from the shelf to scan the bar code or the two-dimensional code and the price of the commodity is displayed on the display window, such that selection of commodity to be purchase is completed; and when the user wants to remove the commodity that has been added to the intelligent shopping cart, the user may directly tap the display window to cancel the commodity. Based on the above, after the user completes the addition of all the commodities, settlement can be clicked on the display window. At this time, the system can settle and generate a payment code according to all the commodities in the intelligent shopping cart, and the user can check out by scanning the code.

In this way, the intelligent shopping cart can scan the identification code of the selected commodity by using its own identification code identifier such as a bar code identifier, and the identification code identifier can be connected to the checkout system through wireless communication. After the identification code corresponding to the commodity is obtained, the settlement can be automatically conducted and a corresponding payment code is generated, then, the user can complete the payment by scanning the payment code, so that the shopping is completed. Since there is no need to wait in line for the settlement, shopping efficiency has been improved significantly.

Based on the above-mentioned method for intelligent shopping, this exemplary arrangement also provides a system for intelligent shopping. As shown in FIG. 4, the system may include a list obtaining module 01, a navigation generation module 02 and a shopping guidance module 03.

The list obtaining module 01 is configured to obtain a list of commodities to be purchased.

The navigation generation module 02 configured to generate a target navigation route according to a current location and a preset area where each commodity to be purchased in the list of commodities to be purchased is located.

The shopping guidance module 03 configured to, according to the target navigation route, guide, in sequence, a user to go to the preset area where each commodity to be purchased in the list of commodities to be purchased is located, for shopping.

The current location and the preset area where each commodity to be purchased in the list of commodities to be purchased is located can be located by the LIDAR (light detection and ranging) sensor mounted on the intelligent shopping cart.

In the system for intelligent shopping provided in the exemplary arrangement of the present disclosure, a target navigation route is automatically generated according to the user's list of commodities to be purchased, so as to guide the user to go to the area where each commodity to be purchased is located for shopping. In this way, by providing the user with a shopping guide route, on the one hand, the user can be guided to the area where each commodity to be purchased is located and this avoids the situation in which the user cannot find the shopping area, thus providing the user with a good shopping experience; on the other hand, the most reasonable shopping route can be customized for users, thus saving shopping time and increasing shopping efficiency.

Considering that the LIDAR sensor can only determines an approximate location, that is, only a rough area can be located, in order to obtain more accurate location, the system for intelligent shopping may further include a communication module.

The communication module is configured to, after guiding a user to go to a preset area where any one of the commodities to be purchased is located according to the target navigation route, create communication with an electronic tag of the any one of the commodities to be purchased to obtain a precise location of the any one of the commodities to be purchased.

In this case, the navigation generation module 02 is further configured to generate a precise navigation route according to the current location and the precise location of the any one of the commodities to be purchased and the shopping guidance module 03 is further configured to guide the user to go to the precise location where the any one of the commodities to be purchased is located.

Further, considering that the intelligent shopping cart will inevitably encounter obstacles in the process of moving, such as a handcart used by a cleaner, a restocking cart used by a stevedore, and other shoppers, in order to ensure that the intelligent shopping cart can reach the target area safely, the system for intelligent shopping may further include an obstacle identifying module.

The obstacle identifying module is configured to automatically avoid obstacles in the course of which the user is guided in sequence to go to the preset area where each commodity to be purchased is located according to the target navigation route and of which the user is guided to go to the precise location where the commodity to be purchased is located according to the precise navigation route.

In this case, the obstacle identifying module can be implemented by using a plurality of ultrasonic sensors installed on the intelligent shopping cart.

In this exemplary arrangement, if a user purchases an in-bulk commodity that needs to be weighed, the user may have to queue up for weighing sometimes, and this may decrease the shopping efficiency. To improve the shopping efficiency for the user, the system for intelligent shopping may further include an information obtaining module, a weighing module and an identification code generation module.

The information obtaining module is configured to obtain commodity information of a commodity to be weighed while purchasing the commodity to be weighed, and the commodity information of the commodity to be weighed may include at least a commodity name and a commodity price.

The weighing module is configured to read out a first weight of the selected commodities, read out a second weight after adding the commodity to be weighed, and obtain the weight of the commodity to be weighed according to the difference between the second weight and the first weight.

The identification code generation module is configured to generate a total price of the commodity to be weighed according to the commodity information and the weight of the weighed commodity, and generate an identification code including the commodity information and the total price.

In this case, the weighing module can be implemented by using the weighing sensor mounted on the intelligent shopping cart.

In this exemplary arrangement, for the purpose of saving the waiting time in line for the checkout and further improving the shopping efficiency of the user, the system for intelligent shopping may further include an identification code identifying module, a payment code generating module and a payment module.

The identification code identifying module is configured to obtain identification codes which correspond to all of the selected commodities and check out according to the identification codes.

The payment code generating module is configured to generate a payment code in response to the result for checkout, and present the same on the display window.

The payment module is configured to receive payment confirmation information generated in response to the payment code so as to complete the shopping.

In this case, the identification code identifying module can be implemented by using the identification code identifier mounted on the intelligent shopping cart, such as a bar code identifier, and the identification code identifier can be connected to the checkout system through wireless communication, such that the commodities can be checked out after the identification code of the commodities are obtained.

It should be noted that the specific details of the intelligent shopping system have been described in detail in the corresponding arrangements of the method for intelligent shopping, and will be omitted here.

In addition, it should also be noted that each module in this arrangement may be configured by a corresponding hardware module, for example, may be implemented by a hardware module such as a processor, an IC, and a logic circuit. Optionally, each module in this arrangement may also be configured by a corresponding software module, for example, the corresponding operations may be performed by executing the corresponding software codes on a processor.

In this exemplary arrangement, the method and the system for intelligent shopping are all implemented based on an intelligent shopping cart. The intelligent shopping cart mainly facilitates fast shopping under the premise that the user is not familiar with the location of the commodity, thus improving the user's shopping efficiency.

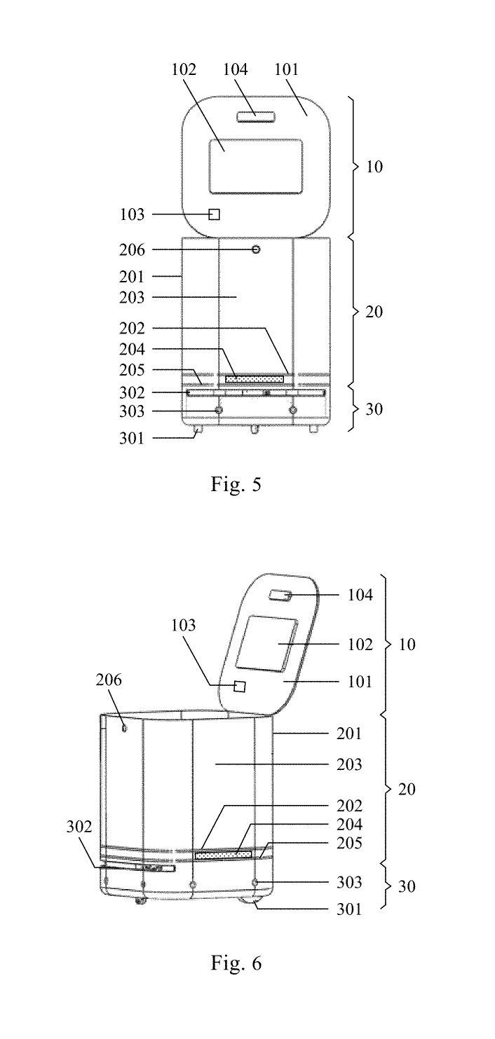

The structure of the intelligent shopping cart of an exemplary arrangement will be described below with reference to the accompanying drawings. FIGS. 5 and 6 show the front and side views of the intelligent shopping cart, respectively. The intelligent shopping cart may include a display identification area 10, a commodity placement area 20, and a drive control area 30.

The display identification area 10 may include a top cover 101 of the intelligent shopping cart, a display window 102 on the top cover 101, a communication device 103, and an identification code identifier 104. The display window 102 is optionally a touch display screen with a touch function.

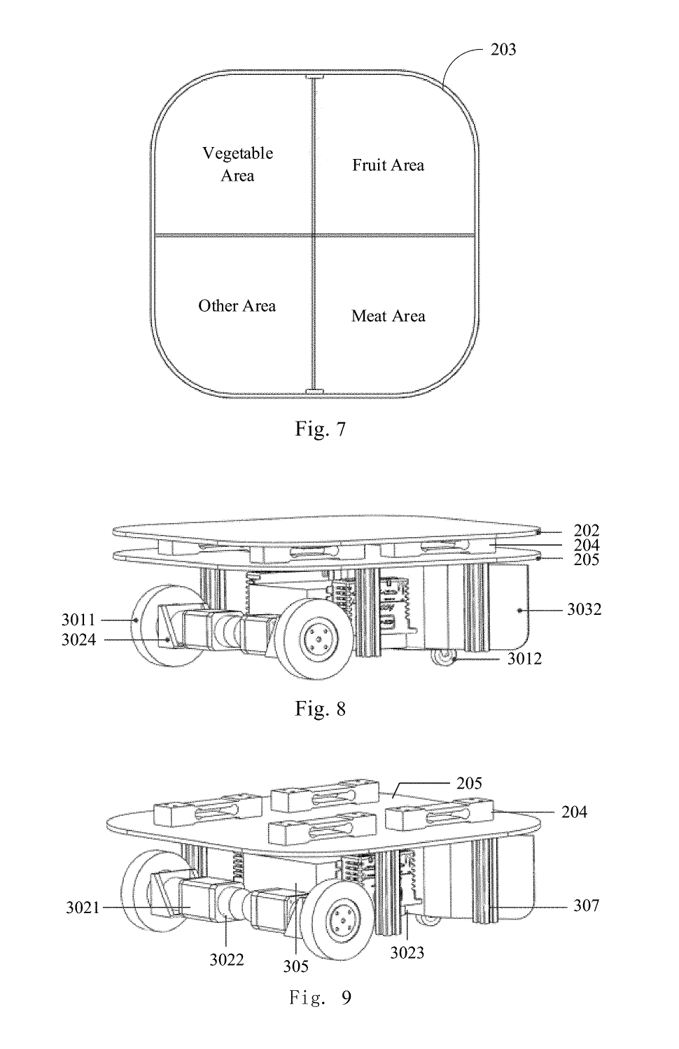

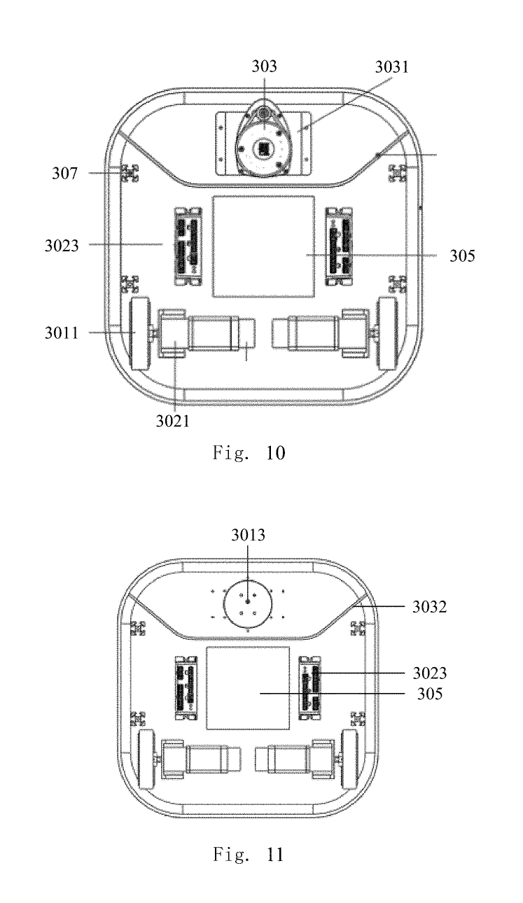

The commodity placement area 20 may include a housing 201 of the intelligent shopping cart, a bearing plate 202 inside the housing 201, a holding chamber 203 on the bearing plate 202, a weighing sensor 204 under the bearing plate 202, a support plate 205 under the weighing sensor 204 and a camera 206 located on the housing 201. The holding chamber 203 can be divided into a plurality of holding areas, as shown in FIG. 7, according to the types of commodities, such as a fruit are, a vegetable area, a meat area, and other areas. FIGS. 8 and 9 are schematic diagrams illustrating implementations of weighing function of the intelligent shopping cart in arrangements of the present disclosure. That is, a plurality of weighing sensors 204 are installed between the support plate 205 and the bearing plate 202, and the number of the weighing sensors 204 may be the same as the number of the holding areas divided by the holding chambers 203.

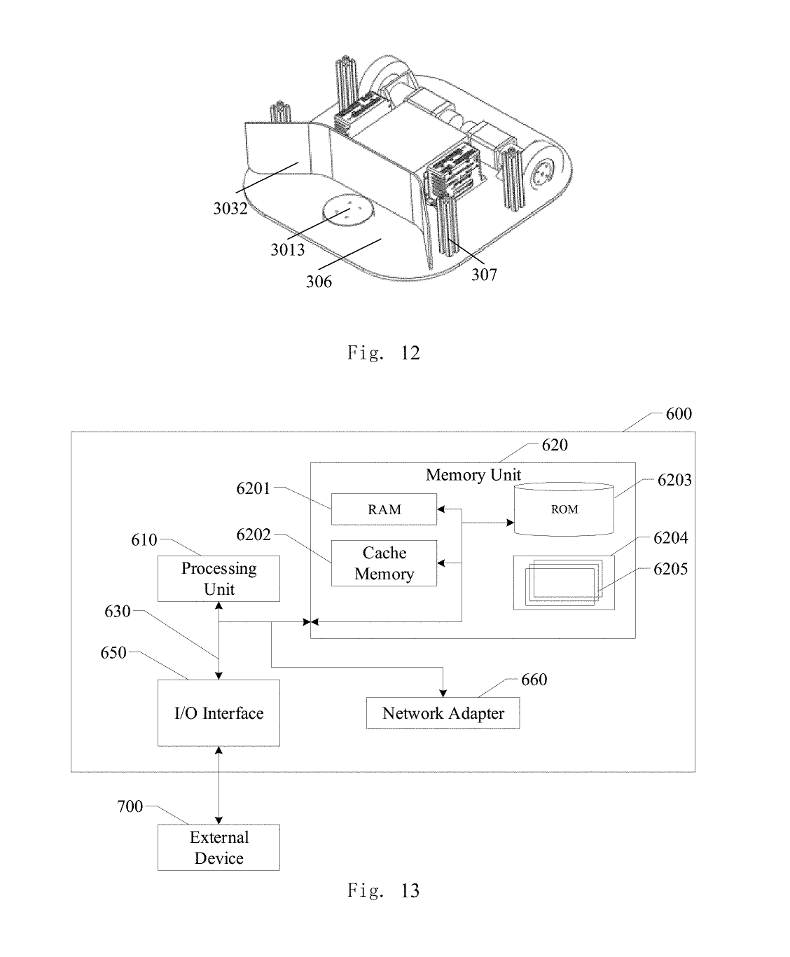

The drive control area 30 may include wheels 301, a drive device 302, an LIDAR sensor 303, an ultrasonic sensor 304, a battery 305, and a bottom plate 306. As shown in FIGS. 10 to 12, the wheels 301 may include two driving wheels 3011 and at least one universal wheel 3012. The universal wheel 3012 is mounted on the universal wheel fixing plate 3013. The drive device 302 may include a motor 3021, a motor encoder 3022, motor drivers 3023 respectively corresponding to the two driving wheels 3011, and a motor flange 3024. The LIDAR sensor 303 is disposed in front of the drive control area 30, that is, the LIDAR sensor 303 is disposed in the direction in which the intelligent shopping cart normally runs. The LIDAR sensor 303 is mounted on the LIDAR sensor support base 3031, and is separated from other components through an LIDAR sensor shutter 3032. The universal wheel fixing plate 3013 is provided below the LIDAR sensor support base 3031. The ultrasonic sensor 304 is disposed in a plurality of directions on the housing 201 of the intelligent shopping cart. The battery 305 is disposed in the center of the drive control area 30. A support pillar 307 is further provided between the bottom plate 306 and the support plate 205.

It should be noted that although several modules or units of the apparatus for action execution are mentioned in the above detailed description, such division is not mandatory. In fact, according to arrangements of the present disclosure, the features and functions of two or more modules or units described above may be embodied in one module or unit. Conversely, the features and functions of one module or unit described above may be further embodied in multiple modules or units.

Moreover, although various blocks of the method in the present disclosure have been described in a specific order in the drawings, this does not require or imply that these blocks must be performed in this particular order, or all illustrated blocks must be performed to achieve the desired result. Additionally or alternatively, blocks may be omitted, multiple blocks may be combined into one block, and/or one block may be divided into multiple blocks to execute.

In an exemplary arrangement of the present disclosure, an electronic device capable of implementing the above method is also provided.

Those of ordinary skill in the art will understand that arrangements of the present disclosure may be implemented as a system, method, or program product. Therefore, various arrangements of the present disclosure may be embodied in the form of an entire hardware implementation, an entire software implementation (including firmware, microcode, etc.), or an implementation combining hardware and software, which can be collectively referred to “circuit”, “module”, or “system” herein.

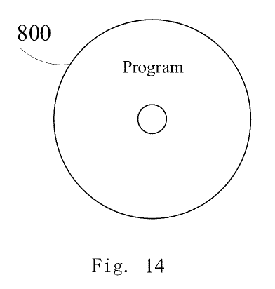

An electronic device 600 according to an arrangement of the present disclosure is described below with reference to FIG. 13. The electronic device 600 shown in FIG. 13 is merely an example, and should not impose any limitation on the functions and the usage scope of the arrangements of the present disclosure.

As shown in FIG. 13, electronic device 600 is represented in the form of a general computing device. The components of the electronic device 600 may include, but is not limited to, the at least one processing unit 610 described above, the at least one memory unit 620 described above, and a bus 630 connecting different system components (including the memory unit 620 and the processing unit 610).

Here, the memory unit 620 stores a program code, and the program code may be executed by the processing unit 610 so that the processing unit 610 performs exemplary arrangements according to the present disclosure described in the above exemplary method section of this specification. For example, the processing unit 610 may perform S1: a list of commodities to be purchased is obtained; S2: a target navigation route is generated according to a current location and a preset area where each commodity to be purchased in the list of commodities to be purchased is located; and S3: according to the target navigation route, a user is guided in sequence to go to the preset area where each commodity to be purchased in the list of commodities to be purchased is located, for shopping, as shown in FIG. 1.

The memory unit 620 may include a readable medium in the form of a volatile memory unit, such as a random access memory unit (RAM) 6201 and/or a cache memory unit 6202, and may further include a read only memory unit (ROM) 6203.

The memory unit 620 may also include a program/utility tool 6204 having a set (at least one) of program modules 6205, such program modules 6205 include but not limit to: an operating system, one or more application programs, other program modules, and program data. Each or some combination of these examples may include the implementation under a network environment.

The bus 630 may represent one or more of several types of bus structures including a memory cell bus or memory cell controller, a peripheral bus, an accelerated graphics port, a processing unit, or a local bus using any of a variety of bus architectures.

The electronic device 600 may also communicate with one or more external devices 700 (e.g., keyboards, pointing devices, bluetooth devices, etc.), may also communicate with one or more devices that enable the user to interact with the electronic device 600, and/or may communicate with any device (e.g., router, modem, etc.) that enables the electronic device 600 to communicate with one or more other computing devices. Such communication may be performed through an input/output (I/O) interface 650. Also, the electronic device 600 may also communicate with one or more networks (e.g., a local area network (LAN), a wide area network (WAN), and/or a public network, such as the Internet) via the network adapter 660. As shown, the network adapter 660 communicates with other modules of electronic device 600 via bus 630. It should be understood that, while not shown in the figures, other hardware and/or software modules may be used in conjunction with the electronic device 600, which include but not limit to: microcode, device drivers, redundant processing units, external disk drive arrays, RAID systems, tape drives and data backup memory systems.

Through the foregoing description of the arrangements, those skilled in the art can easily understand that the exemplary arrangements described herein can be implemented by software, and can also be implemented by software in combination with necessary hardware. Therefore, the technical solutions according to the arrangements of the present disclosure can be embodied in the form of a software product that can be stored in a non-volatile storage medium (which may be a CD-ROM, U disk, mobile hard disk, etc.) or on a network. The software product may include several instructions to enable a computing device (which may be a personal computer, a server, a terminal device, or a network device, etc.) to perform a method according to an arrangement of the present disclosure.

In an exemplary arrangement of the present disclosure, there is also provided a computer-readable storage medium on which a program product capable of implementing the method described above in this specification is stored. In some possible implementations, various arrangements of the present disclosure may also be implemented in the form of a program product including a program code for causing the terminal device to perform the blocks according to various exemplary arrangements of the present disclosure described in the above exemplary method section of the present specification when the program product is executed on the terminal device.

With reference to FIG. 14, a program product 800 for implementing the above method according to an arrangement of the present disclosure is described. The program product 800 may employ a portable compact disc read-only memory (CD-ROM) and include program code, and may be executed on a terminal device, such as a personal computer. However, the program product of the present disclosure is not limited thereto, and in this document, the readable storage medium may be any tangible medium that contains or stores program that can be used by or in conjunction with an instruction execution system, apparatus, or device.

The program product may employ any combination of one or more readable medium. The readable medium may be a readable signal medium or a readable storage medium. A readable storage medium may be, but not limited to, for example an electronic, magnetic, optical, electromagnetic, infrared, or semiconductor system, apparatus, or device, or any combination thereof. More specific (non-exhaustive) examples of readable storage medium include: electrical connections with one or more wires, portable disks, hard disks, a random access memory (RAM), a read only memory (ROM), an erasable programmable read-only memory (EPROM or flash memory), an optical fiber, a portable compact disc read-only memory (CD-ROM), an optical storage device, a magnetic storage device, or any suitable combination thereof.

A computer readable signal medium may include a data signal that propagates in baseband or as part of carrier wave, and the data signal carries readable program code. Such propagated data signals may have a variety of forms, including but not limited to electromagnetic signals, optical signals, or any suitable combination of the above. The readable signal medium may also be any readable medium other than a readable storage medium, which can transmit, propagate, or transport a program for use by or in connection with an instruction execution system, apparatus, or device.

The program code embodied on the readable medium may be transmitted using any appropriate medium, including but not limited to wireless, wire, optical fiber cable, RF, or any suitable combination thereof.

Program code for carrying out operations of the present disclosure may be programmed in any combination of one or more programming languages including object-oriented programming languages such as Java, C++, and the like, as well as conventional process-oriented programming languages such as the “C” language or similar programming languages. The program code may be executed entirely on the user's computing device, or partly on the user's device, or the program code may be as a stand-alone software package to be executed, or a part of the program code can be executed on the user's computing device and other part of the program code can be executed on the remote computing device, or the program code may be executed entirely on the remote computing device or server. In situations related to remote computing devices, the remote computing device may be connected to the user computing device through any type of network, including a local area network (LAN) or a wide area network (WAN), or may be connected to an external computing device (e.g., using the internet provided by a network service provider).

In addition, the above-mentioned drawings are merely schematic illustrations for processes included in the method according to an exemplary arrangement of the present disclosure, and are not restrictive for the present disclosure. It is readily understood that the processes illustrated in the above drawings do not indicate or limit the chronological order of these processes. In addition, it is also easily understood that these processes may be executed synchronously or asynchronously, for example, in a plurality of modules.

Those skilled in the art will readily recognize other arrangements of the present disclosure upon consideration of the specification and practice of the disclosure herein. The present disclosure is intended to cover any variations, uses, or adaptations of the present disclosure which follow the general principles of the present disclosure and include any common knowledge or customary technical means in the art that is not disclosed by the present disclosure. The specification and examples are considered as being exemplary only, with the true scope and spirit of the present disclosure being indicated by the following claims.

It should be understood that the present disclosure is not limited to the precise structure that has been described above and shown in the drawings, and various modifications and changes can be made without departing from the scope thereof. The scope of the present disclosure is limited only by the appended claims.

What is claimed is:

1. A method for intelligent shopping, comprising:
obtaining a list of commodities to be purchased;
generating a target navigation route according to a current location and a preset area where each commodity to be purchased in the list of commodities to be purchased is located; and
according to the target navigation route, guiding, in sequence, a user to go to the preset area where each commodity to be purchased in the list of commodities to be purchased is located, for shopping.

2. The method according to claim 1, wherein the obtaining the list of commodities to be purchased, comprising:
creating communication with a client on which the list of commodities to be purchased is stored to obtain the list of commodities to be purchased.

3. The method according to claim 1, wherein the obtaining the list of commodities to be purchased, comprising:
receiving a shopping instruction for pre-selecting the commodities to be purchased; and
generating the list of commodities to be purchased according to the shopping instruction.

4. The method according to claim 2, wherein the obtaining a list of commodities to be purchased, comprising:
receiving a shopping instruction for pre-selecting the commodities to be purchased; and
generating the list of commodities to be purchased according to the shopping instruction.

5. The method according to claim 1, wherein the generating the target navigation route according to the current location and the preset area where each commodity to be purchased in the list of commodities to be purchased is located, comprising:
generating a plurality of navigation routes according to the preset area where each commodity to be purchased in the list of commodities to be purchased is located;
displaying the plurality of the navigation routes on a display window; and
receiving one selected navigation route, which is selected in response to the plurality of the navigation routes, to be the target navigation route.

6. The method according to claim 1, wherein the generating the target navigation route according to the current location and the preset area where each commodity to be purchased in the list of commodities to be purchased is located, comprising:
searching, in a shopping system, for at least one piece of commodity information matched with one or more commodities to be purchased in the list of commodities to be purchased according to the one or more commodities to be purchased;
displaying the at least one piece of commodity information on a display window;
receiving the one or more commodities to be purchased which are selected in response to the at least one piece of commodity information; and
generating the target navigation route according to preset areas where the one or more commodities to be purchased are located.

7. The method according to claim 5, wherein the generating the target navigation route according to the current location and the preset area where each commodity to be purchased in the list of commodities to be purchased is located, comprising:
searching, in a shopping system, for at least one piece of commodity information matched with one or more commodities to be purchased in the list of commodities to be purchased according to the one or more commodities to be purchased;
displaying the at least one piece of commodity information on a display window;
receiving the one or more commodities to be purchased which are selected in response to the at least one piece of commodity information; and
generating the target navigation route according to preset areas where the one or more commodities to be purchased are located.

8. The method according to claim 1, wherein after guiding the user to go to the preset area where any one of the commodities to be purchased is located according to the target navigation route, the method further comprises:
creating communication with an electronic tag of the any one of the commodities to be purchased to obtain a precise location of the any one of the commodities to be purchased;
generating a precise navigation route according to the current location and the precise location of the any one of the commodities to be purchased; and
guiding the user to go to the precise location where the any one of the commodities to be purchased is located according to the precise navigation route.

9. The method according to claim 1, further comprising:
obtaining commodity information of a commodity to be weighed while purchasing the commodity to be weighed, wherein the commodity information of the commodity to be weighed comprises a commodity price;
reading out a first weight of the selected commodities;
reading out a second weight after adding the commodity to be weighed;
obtaining the weight of the commodity to be weighed according to a difference between the second weight and the first weight;
generating a total price of the commodity to be weighed according to the commodity information and the weight of the weighed commodity; and
generating an identification code including the commodity information and the total price.

10. A system for intelligent shopping, comprising:
a list obtaining module configured to obtain a list of commodities to be purchased;
a navigation generation module configured to generate a target navigation route according to a current location and a preset area where each commodity to be purchased in the list of commodities to be purchased is located; and
a shopping guidance module configured to, according to the target navigation route, guide, in sequence, a user to go to the preset area where each commodity to be purchased in the list of commodities to be purchased is located, for shopping.

11. The system according to claim 10, further comprising:
a communication module configured to, after guiding the user to go to the preset area where any one of the commodities to be purchased is located according to the target navigation route, create communication with an electronic tag of the any one of the commodities to be purchased to obtain a precise location of the any one of the commodities to be purchased;
wherein the navigation generation module is further configured to generate a precise navigation route according to the current location and the precise location of the any one of the commodities to be purchased; and
the shopping guidance module is further configured to guide the user to go to the precise location where the any one of the commodities to be purchased is located according to the precise navigation route.

12. The system according to claim 10, further comprising:
an information obtaining module configured to obtain commodity information of a commodity to be weighed while purchasing the commodity to be weighed, wherein the commodity information of the commodity to be weighed comprises a commodity price;
a weighing module configured to read out a first weight of the selected commodities, read out a second weight after adding the commodity to be weighed, and obtain the weight of the commodity to be weighed according to a difference between the second weight and the first weight;
an identification code generation module configured to generate a total price of the commodity to be weighed according to the commodity information and the weight of the weighed commodity, and generate an identification code including the commodity information and the total price.

13. A system for intelligent shopping, comprising:
a processor; and
a memory in which instruction executable for the processor is stored;
wherein, the processor is configured to
obtain a list of commodities to be purchased;
generate a target navigation route according to a current location and a preset area where each commodity to be purchased in the list of commodities to be purchased is located; and
according to the target navigation route, guide, in sequence, a user to go to the preset area where each commodity to be purchased in the list of commodities to be purchased is located, for shopping.

14. The system according to claim 13, wherein the processor is further configured to:
after guiding the user to go to the preset area where any one of the commodities to be purchased is located according to the target navigation route, create communication with an electronic tag of the any one of the commodities to be purchased to obtain a precise location of the any one of the commodities to be purchased;
generate a precise navigation route according to the current location and the precise location of the any one of the commodities to be purchased; and
guide the user to go to the precise location where the any one of the commodities to be purchased is located according to the precise navigation route.

15. The system according to claim 13, wherein the processor is further configured to:
obtain commodity information of a commodity to be weighed while purchasing the commodity to be weighed, the commodity information of the commodity to be weighed comprising a commodity price;
read out a first weight of the selected commodities, read out a second weight after adding the commodity to be weighed, and obtain the weight of the commodity to be weighed according to a difference between the second weight and the first weight; and
generate a total price of the commodity to be weighed according to the commodity information and the weight of the weighed commodity, and generate an identification code including the commodity information and the total price.

16. An intelligent shopping cart, comprising a display identification area, a commodity placement area and a drive control area, wherein
the display identification area comprises a communication device and a display window, at least one of the communication device and the display window being configured to obtain a list of commodities to be purchased;
the commodity placement area comprises a bearing plate and a holding chamber on the bearing plate; and
the drive control area comprises wheels, a drive device and an LIDAR sensor,
wherein the LIDAR sensor is configured to obtain a current location and a location in a preset area where each commodity to be purchased in the list of commodities to be purchased is located, and guide a user to go to the preset area where each commodity to be purchased is located.

17. The intelligent shopping cart according to claim 16, wherein the commodity placement area further comprises a weighing sensor under the bearing plate.

18. A non-transitory computer readable medium, in which instruction is stored, wherein, when the instruction is executed by a processor of a system for intelligent shopping, the system:
obtains a list of commodities to be purchased;
generates a target navigation route according to a current location and a preset area where each commodity to be purchased in the list of commodities to be purchased is located; and
according to the target navigation route, guides, in sequence, a user to go to the preset area where each commodity to be purchased in the list of commodities to be purchased is located, for shopping.
